(19) United States
(12) Patent Application Publication
(10) Pub. No.: US 2021/0037578 A1
(43) Pub. Date: Feb. 4, 2021

(54) METHOD, APPARATUS AND SYSTEM FOR ESTABLISHING CONNECTION BETWEEN TERMINAL AND CORE NETWORK TO BE ACCESSED

(71) Applicants: BEIJING XIAOMI MOBILE SOFTWARE CO., LTD., Beijing (CN); BEIJING UNIVERSITY OF POSTS AND TELECOMMUNICATIONS, Beijing (CN)

(72) Inventors: Wei HONG, Beijing (CN); Yajun ZHU, Beijing (CN); Yong LI, Beijing (CN)

(73) Assignees: BEIJING XIAOMI MOBILE SOFTWARE CO., LTD., Beijing (CN); BEIJING UNIVERSITY OF POSTS AND TELECOMMUNICATIONS, Beijing (CN)

(21) Appl. No.: 16/967,305

(22) PCT Filed: Feb. 9, 2018
(86) PCT No.: PCT/CN2018/075978

§ 371 Date: Aug. 4, 2020

(51) Int. Cl. H04W 76/10; H04W 48/16; H04W 88/06

(52) U.S. Cl. CPC H04W 76/10; H04W 88/06; H04W 48/16

(57) ABSTRACT

Aspects of the disclosure provide a method, apparatus, and system for establishing a connection between a terminal and a core network to be accessed, which fall within the technical field of wireless communications. The method can include receiving signaling sent by a terminal, wherein the signaling includes information indicating that a core network type corresponding to a core network to be accessed by the terminal is a target type. The method can further include determining the target type indicated by the information, and establishing a connection between the terminal and the core network corresponding to the target type. The core network corresponding to the target type is the core network to be accessed by the terminal. By means of the present disclosure, a connection can be established between a terminal and a core network to be accessed.

### RELATED APPLICATION

This application claims the benefit of International Application No. PCT/CN2018/075978, entitled “Method, Apparatus and System For Establishing Connection Between Terminal and Core Network to be Accessed” and filed on Feb. 9, 2018, which is incorporated herein by reference in its entirety

### TECHNICAL FIELD

The present disclosure relates to the technical field of wireless communication, including a method, device, and system for establishing a connection between a terminal and a core network to be accessed.

### BACKGROUND

Along with the development of wireless communication technologies, 4th-Generation (4G) mobile networks have been widely applied. For enabling a terminal to transmit data through a mobile network, a base station may establish a connection between the terminal and a 4G core network corresponding to the 4G mobile network in a random access process. However, along with the further development of the wireless communication technologies, a 4G mobile network and mobile network of another type, for example a 5th-Generation (5G) mobile network, may share the same base station in an environment. Therefore, there is a need to provide a method for establishing a connection between a terminal and a core network to be accessed at present.

### SUMMARY

The present disclosure provides a method, device and system for establishing a connection between a terminal and a core network to be accessed.

According to a first aspect of the present disclosure, a method for establishing a connection between a terminal and a core network to be accessed is provided. The method can include that a target type corresponding to a core network to be accessed is determined, an signaling is sent to a base station, the signaling including information for indicating that a core network type corresponding to the core network to be accessed by a terminal is the target type.

Optionally, the operation that the signaling is sent to the base station may include that, if the target type is a first type, signaling including an information element of which a value is first data is sent to the base station, the information element of which the value is the first data being used to indicate that the target type is the first type.

Further, the operation that the signaling is sent to the base station may include that, if the target type is a second type, signaling excluding the information element of which the value is the first data is sent to the base station or, if the target type is the second type, signaling including an information element of which a value is second data is sent to the base station, the information element of which the value is the second data being used to indicate that the target type is the second type. Additionally, when the first data is true, the second data may be false, and when the first data is an identifier of the first type, the second data may be an identifier of the second type.

According to a second aspect of the embodiments of the present disclosure, a method for establishing a connection between a terminal and a core network to be accessed is provided, which may include that signaling is received from a terminal, the signaling including information for indicating that a core network type corresponding to a core network to be accessed by the terminal is a target type, the target type indicated by the information is determined, and a connection is established between the terminal and a core network corresponding to the target type, where the core network corresponding to the target type is the core network to be accessed by the terminal.

Optionally, the operation that the signaling is received from the terminal may include that signaling including an information element of which a value is first data is received from the terminal, the information element of which the value is the first data being used to indicate that the target type is a first type, and the operation that the target type indicated by the information is determined may include that it is determined that the target type indicated by the information is the first type.

Additionally, the operation that the signaling sent by the terminal is received may include that signaling including the information element of which the value is the first data is received from the terminal or, signaling including an information element of which a value is second data is received from the terminal, the information element of which the value is the second data being configured to indicate that the target type is a second type, and the operation that the target type indicated by the information is determined may include that it is determined that the target type indicated by the information is the second type. Optionally, when the first data is true, the second data may be false, and when the first data is an identifier of the first type, the second data may be an identifier of the second type.

According to a third aspect of the embodiments of the present disclosure, a device for establishing a connection between a terminal and a core network to be accessed is provided, which may be a terminal and include a determination module that is configured to determine a target type corresponding to a core network to be accessed, and a sending module that is configured to send signaling to a base station, the signaling including information for indicating that a core network type corresponding to the core network to be accessed by a terminal is the target type.

Optionally, the sending module may be configured to, if the target type is a first type, send signaling including an information element of which a value is first data to the base station, the information element of which the value is the first data being used to indicate that the target type is the first type. Additionally, the sending module may be configured to, if the target type is a second type, send signaling excluding the information element of which the value is the first data to the base station, or, if the target type is the second type, send signaling including an information element of which a value is second data to the base station, the information element of which the value is the second data being used to indicate that the target type is the second type. Further, when the first data is true, the second data may be false, and, when the first data is an identifier of the first type, the second data may be an identifier of the second type.

According to a fourth aspect of the embodiments of the present disclosure, a device for establishing a connection between a terminal and a core network to be accessed is provided, which may be a base station and include a receiving module that is configured to receive signaling from a terminal, the signaling including information for indicating that a core network type corresponding to a core network to be accessed by the terminal is a target type, a determination module that is configured to determine the target type indicated by the information, and an establishment module that is configured to establish a connection between the terminal and a core network corresponding to the target type, where the core network corresponding to the target type is the core network to be accessed by the terminal. Optionally, the receiving module may be configured to receive signaling including an information element of which a value is first data from the terminal, the information element of which the value is the first data being configured to indicate that the target type is a first type, and the determination module may be configured to determine that the target type indicated by the information is the first type. Further, the receiving module may be configured to receive signaling excluding the information element of which the value is the first data from the terminal, or receive signaling including an information element of which a value is second data from the terminal, the information element of which the value is the second data being used to indicate that the target type is a second type. Further, the determination module may be configured to determine that the target type indicated by the information is the second type.

Optionally, when the first data is true, the second data may be false, and, when the first data is an identifier of the first type, the second data may be an identifier of the second type.

According to a fifth aspect of the embodiments of the present disclosure, a terminal is provided, which may include a processor and a memory, where the memory is configured to store at least one instruction, at least one segment of program, a code set or an instruction set that, when being loaded and executed by the processor, enables the processor to implement the method for establishing the connection between the terminal and the core network to be accessed according to the first aspect.

According to a sixth aspect of the embodiments of the present disclosure, a base station is provided, which may include a processor and a memory, wherein the memory is configured to store at least one instruction, at least one segment of program, a code set or an instruction set that, when being loaded and executed by the processor, enables the processor to implement the method for establishing the connection between the terminal and the core network to be accessed according to the second aspect.

According to a seventh aspect of the embodiments of the present disclosure, a computer-readable storage medium is provided, characterized by having stored therein at least one instruction, at least one segment of program, a code set or an instruction set that, when being loaded and executed by a processor, enable the processor to implement the method for establishing the connection between the terminal and the core network to be accessed according to the first aspect or the method for establishing the connection between the terminal and the core network to be accessed according to the second aspect.

According to an eighth aspect of the embodiments of the present disclosure, a system for establishing a connection between a terminal and a core network to be accessed is provided, characterized by including a terminal and a base station, where the terminal may be the terminal according to the third aspect and the fifth aspect; and the base station may be the base station according to the fourth aspect and the sixth aspect.

The technical solutions provided by the embodiments of the present disclosure have the beneficial effects. For example, in the embodiments of the present disclosure, the terminal may determine the target type corresponding to the core network to be accessed and send the signaling to the base station, the signaling including the information for indicating that the core network type corresponding to the core network to be accessed by the terminal is the target type. Correspondingly, the base station, after receiving the signaling from the terminal, may determine the target type indicated by the information in the signaling and establish the connection between the terminal and the core network corresponding to the target type, where the core network corresponding to the target type is the core network to be accessed by the terminal. Therefore, the base station may correctly establish the connection between the terminal and the core network to be accessed by the terminal, namely the embodiments of the present disclosure provide a method for establishing a connection between a terminal and a core network to be accessed.

### BRIEF DESCRIPTION OF THE DRAWINGS

In order to describe the technical solutions in the embodiments of the present disclosure more clearly, the accompanying drawings required to be used for descriptions about the embodiments will be simply introduced below. It is apparent that the accompanying drawings described below are only some exemplary embodiments of the present disclosure. Those of ordinary skill in the art may further obtain other accompanying drawings according to these accompanying drawings without creative work.

FIG. 1 is a structure diagram of a system according to an exemplary embodiment of the present disclosure.

FIG. 2 is a flow chart showing a method for establishing a connection between a terminal and a core network to be accessed according to an exemplary embodiment of the present disclosure.

FIG. 3 is a structure diagram of a system, according to an exemplary embodiment of the present disclosure.

FIG. 4 is a structure diagram of a device for establishing a connection between a terminal and a core network to be accessed, according to an exemplary embodiment of the present disclosure.

FIG. 5 is a structure diagram of a device for establishing a connection between a terminal and a core network to be accessed, according to an exemplary embodiment of the present disclosure.

FIG. 6 is a device structure diagram of a terminal, according to an exemplary embodiment of the present disclosure.

FIG. 7 is a device structure diagram of a base station, according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

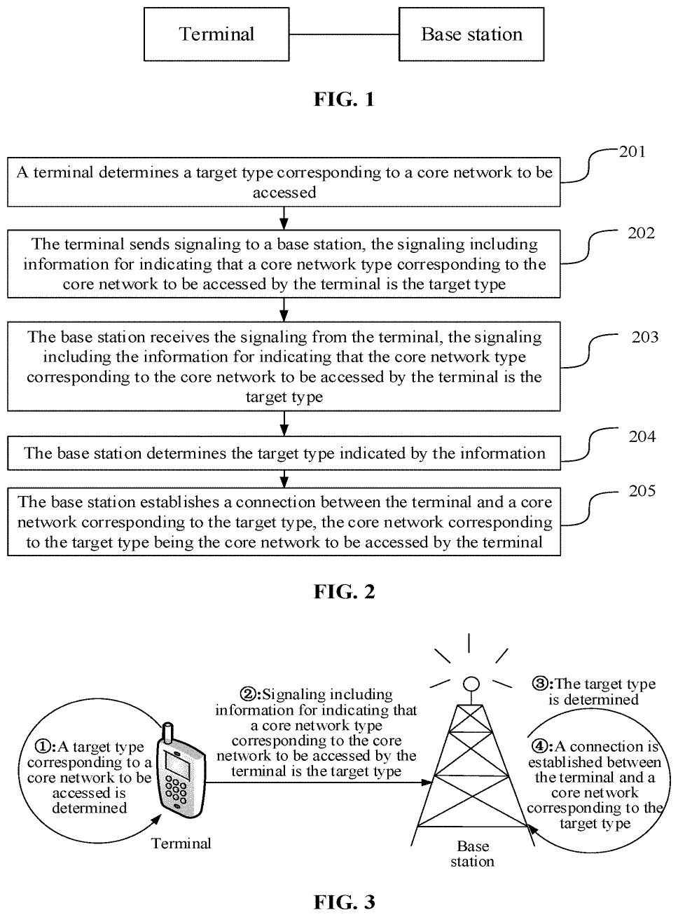

An exemplary embodiment of the present disclosure provides a method for establishing a connection between a terminal and a core network to be accessed. The method may be implemented by a base station and a terminal together. A structure diagram of a system is shown in FIG. 1. The base station may be a base station in a wireless communication system, and for example, may be an Evolutional Node B (eNB or e-NodeB) in Long Term Evolution (LTE). The terminal may also be called User Equipment (UE), a Mobile Station (MS), a mobile terminal and the like. For example, the terminal may be a mobile phone (or called a “cell” phone). For example, the terminal may also be a portable, pocket, handheld, computer-embedded or vehicle-mounted mobile device, and exchanges languages and/or data with a radio access network. The terminal, after determining a target type corresponding to a core network to be accessed, may send signaling to the base station, the signaling including information for indicating that a core network type corresponding to the core network to be accessed by the terminal is the target type. The base station, after receiving the signaling, may determine the target type indicated by the information in the signaling and establish a connection between the terminal and a core network corresponding to the target type.

The terminal may include components such as a processor, a memory and a transceiver. The processor may be a Central Processing Unit (CPU) and the like, and may be configured for related processing of determining the target type corresponding to the core network to be accessed. The memory may be a Random Access Memory (RAM), a flash and the like, and may be configured to store received data, data required in a processing process, data generated in the processing process and the like. The transceiver may be configured to perform data transmission with another device, for example, sending the signaling to the base station, and may include an antenna, a matching circuit, a modem and the like.

The base station may include components such as a processor, a memory and a transceiver. The processor may be a CPU and the like, and may be configured for related processing of determining the target type indicated by the information in the signaling sent by the terminal and establishing the connection between the terminal and the core network corresponding to the target type. The memory may be a RAM, a flash and the like, and may be configured to store received data, data required in a processing process, data generated in the processing process and the like, for example, the signaling sent by the terminal after determining the target type corresponding to the core network to be accessed. The transceiver may be configured to perform data transmission with another device, for example, receiving the signaling sent by the terminal, and the transceiver may include an antenna, a matching circuit, a modem and the like.

A processing flow shown in FIG. 2 will be described below in combination with an implementation mode in detail, which may be as follows.

In Step 201, a terminal determines a target type corresponding to a core network to be accessed. In an implementation, during operation, the terminal may determine a type (which may be called the target type) corresponding to the core network to be accessed this time based on present state information. The target type may be a 4G core network (EPC), and may also be a 5G Core Network (5GCN). For example, when the terminal simultaneously detects a 4G mobile network and a 5G mobile network, it may be determined that the target type corresponding to the core network to be accessed is the 5GCN, and when the terminal only detects the 4G mobile network, it may be determined that the target type corresponding to the core network to be accessed is the 4G core network.

In Step 202, the terminal sends signaling to a base station, the signaling including information used for indicating that a core network type corresponding to the core network to be accessed by the terminal is the target type.

During implementation, the terminal, after determining the target type corresponding to the core network to be accessed, may send the signaling to the base station, as shown in FIG. 3. The signaling may include the information for indicating that the core network type corresponding to the core network to be accessed by the terminal is the target type, and the signaling may further include other information and is not limited herein. Specifically, the terminal may add the information for indicating that the core network type corresponding to the core network to be accessed by the terminal is the target type to signaling of a message 5 (where the message 5 is a message sent by the terminal for the fifth time in the random access process) in a random access process, and the signaling in the message 5 may be Radio Resource Control (RRC) ConnectionSetupComplete signaling. That is, the terminal may indicate the core network type corresponding to the core network to be accessed by itself to the base station through the RRCConnectionSetupComplete signaling of the message 5.

Optionally, the terminal may adopt different information to indicate different target types. When the target type is a first type, the processing process of Step 202 may be as follows: if the target type is the first type, signaling including an information element of which a value is first data is sent by the terminal to the base station, the information element of which the value is the first data being used to indicate that the target type is the first type.

During implementation, if the target type is the first type, the terminal may set the value of the information element to be the first data and send the signaling including the information element to the base station. The information element of which the value is the first data may be used to indicate the base station that the target type is the first type, and the first type may be the 4G core network or the 5GCN.

The information element may be an information element of an enumerated type, and the first data may be true. Or, the information element may be an information element of the enumerated type, and the first data may be an identifier of the first type. Or, the information element may be an information element of a BOOLEAN type, and the first data may be true. Optionally, the target type may be a second type, the second type being different from the first type. When the first type is the 4G core network, the second type is the 5GCN; and when the first type is the 5GCN, the second type is the 4G core network.

Based on different manners, various processing manners may be adopted for Step 202. The following feasible processing manners are presented.

In a first manner, if the target type is the second type, signaling excluding the information element of which the value is the first data is sent to the base station. During implementation, if the target type is the second type, the terminal may send the signaling excluding the information element to the base station. That is, for the condition that the information element is of the enumerated type and the first data is true when the target type is the first type, when the target type is the second type, the terminal may send signaling excluding the information element of which the value is true to the base station. Under this condition, implementation of the ConnectionSetupComplete signaling may be as follows:

ASN1START
RRCConnectionSetupComplete ::= SEQUENCE {

| | |
|---|---|
| rrc-TransactionIdentifier | RRC-TransactionIdentifier, |

| | |
|---|---|
| criticalExtensions | CHOICE { |

| | |
|---|---|
| c1 | CHOICE{ |

| | |
|---|---|
| rrcConnectionSetupComplete-r8 | RRCConnectionSetupComplete-r8-IEs, |

spare3 NULL, spare2 NULL, spare1 NULL

| }, | |
|---|---|
| criticalExtensionsFuture | SEQUENCE { } |

}

}
... ... ...
RRCConnectionSetupComplete-v1330-IEs ::= SEQUENCE {

| | | |
|---|---|---|
| ue-CE-NeedULGaps-r13 | ENUMERATED {true} | OPTIONAL, |

nonCriticalExtension RRCConnectionSetupComplete-v1430-IEs OPTIONAL
}
RRCConnectionSetupComplete-v1430-IEs ::= SEQUENCE {

| | | |
|---|---|---|
| dcn-ID-r14 | INTEGER (0..65535) | OPTIONAL, |

| | |
|---|---|
| nonCriticalExtension | RRCConnectionSetupComplete-v15-IEs |

OPTIONAL
}
RRCConnectionSetupComplete-v15-IEs ::= SEQUENCE {

| | | |
|---|---|---|
| 5GCN-r15 | ENUMERATED {true} | OPTIONAL, |

| | | |
|---|---|---|
| nonCriticalExtension | SEQUENCE {} | OPTIONAL |

}
-- ASN1STOP.

When the first type is 5GCN, the RRCConnectionSetupComplete signaling may include an information element “5GCN-r15 ENUMERATED {true}OPTIONAL”, and when the first type is the 4G core network, the RRCConnectionSetupComplete signaling may not include the information element “5GCN-r15 ENUMERATED {true} OPTIONAL”.

In a second manner, if the target type is the second type, signaling including an information element of which a value is second data is sent to the base station, the information element of which the value is the second data being used to indicate that the target type is the second type.

During implementation, if the target type is the second type, the terminal may set the value of the information element to be the second data and send the signaling including the information element to the base station. The information element of which the value is the second data may be used to indicate the base station that the target type is the second type.

For the condition that the information element is an information element of the enumerated type and the first data is the identifier of the first type when the target type is the first type, correspondingly, when the target type is the second type, the second data may be an identifier of the second type. Under this condition, implementation of the RRCConnectionSetupComplete signaling sent to the base station by the terminal may be as follows:

| ASN1START | |
|---|---|
| RRCConnectionSetupComplete ::= | SEQUENCE { |

| | |
|---|---|
| rrc-TransactionIdentifier | RRC-TransactionIdentifier, |

| | |
|---|---|
| criticalExtensions | CHOICE { |

| | |
|---|---|
| c1 | CHOICE { |

| | |
|---|---|
| rrcConnectionSetupComplete-r8 | RRCConnectionSetupComplete-r8-IEs, |

spare3 NULL, spare2 NULL, spare1 NULL

| }, | |
|---|---|
| criticalExtensionsFuture | SEQUENCE { } |

}

| } | | |
|---|---|---|
| ... ... ... | | |
| RRCConnectionSetupComplete-v1330-IEs ::= SEQUENCE { | | |
| ue-CE-NeedULGaps-r13 | ENUMERATED {true} | OPTIONAL, |
| nonCriticalExtension RRCConnectionSetupComplete-v1430-IEs OPTIONAL | | |
| } | | |
| RRCConnectionSetupComplete-v14430-IEs ::= SEQUENCE { | | |
| dcn-ID-r14 | INTEGER (0..65535) | OPTIONAL, |

nonCriticalExtension RRCConnectionSetupComplete-v15-IEs
OPTIONAL
}
RRCConnectionSetupComplete-vl5-IEs ::= SEQUENCE {

| | |
|---|---|
| corenetworkType-r15 | ENUMERATED {identifier of the first type, |

identifier of the second type} OPTIONAL,

| | | |
|---|---|---|
| nonCriticalExtension | SEQUENCE { } | OPTIONAL |

}
-- ASN1STOP.

An identifier of the 4G core network may be EPC, and an identifier of the 5GCN may be 5GCN. When the target type is the first type, the value of the information element may be the identifier of the first type, and when the target type is the second type, the value of the information element may be the identifier of the second type.

In addition, for the condition that the information element is an information element of the BOOLEAN type and the first data is true when the target type is the first type, correspondingly, when the target type is the second type, the second data may be false, and implementation of the RRCConnectionSetupComplete signaling sent to the base station by the terminal may be as follows:

ASN1START

| RRCConnectionSetupComplete ::= | | SEQUENCE { |
|---|---|---|
| | rrc-TransactionIdentifier | RRC-TransactionIdentifier, |

| | |
|---|---|
| criticalExtensions | CHOICE { |

| | |
|---|---|
| c1 | CHOICE { |

| | |
|---|---|
| rrcConnectionSetupComplete-r8 | RRCConnectionSetupComplete-r8-IEs, |

spare3 NULL, spare2 NULL, spare1 NULL

| }, | |
|---|---|
| criticalExtensionsFuture | SEQUENCE { } |

}

}
... ... ...
RRCConnectionSetupComplete-v1330-IEs ::= SEQUENCE {

| | | |
|---|---|---|
| ue-CE-NeedULGaps-r13 | ENUMERATED {true} | OPTIONAL, |

nonCriticalExtension RRCConnectionSetupComplete-v1430-IEs OPTIONAL
}
RRCConnectionSetupComplete-v1430-IEs ::= SEQUENCE {

| | | |
|---|---|---|
| dcn-ID-r14 | INTEGER (0..65535) | OPTIONAL, |

nonCriticalExtension RRCConnectionSetupComplete-v15-IEs
OPTIONAL
}
RRCConnectionSetupComplete-v15-IEs ::= SEQUENCE {

| | | |
|---|---|---|
| 5GCN-r15 | BOOLEAN | OPTIONAL, |

| | |
|---|---|
| nonCriticalExtension | SEQUENCE { } OPTIONAL |

}
-- ASN1STOP.

When the target type is the 5GCN, the terminal may set the value of the information element to be true, and when the target type is the 4G core network, the terminal may set the value of the information element to be false.

In Step 203, the base station receives the signaling from the terminal, the signaling including the information indicating that the core network type corresponding to the core network to be accessed by the terminal is the target type.

During implementation, after the terminal sends the corresponding signaling to the base station, the base station may receive the signaling sent by the terminal. Optionally, in condition that the signaling sent to the base station by the terminal includes the information element of which the value is the first data, correspondingly, the processing process of Step 203 may be as follows. The signaling including the information element of which the value is the first data is received from the terminal, the information element of which the value is the first data being used to indicate that the target type is the first type.

During implementation, after the terminal sends the signaling including the information element of which the value is the first data to the base station, the base station may receive the signaling including the information element of which the value is the first data from the terminal. Optionally, in condition that the signaling sent to the base station by the terminal does not include the information element of which the value is the first data, correspondingly, the processing process of Step 203 may be as follows. The signaling excluding the information element of which the value is the first data is received from the terminal.

During implementation, after the terminal sends the signaling excluding the information element of which the value is the first data to the base station, the base station may receive the signaling excluding the information element of which the value is the first data from the terminal. Optionally, in condition that the signaling sent by the terminal to the base station includes the information element of which the value is the second data, correspondingly, the processing process of Step 203 may be as follows. The signaling including the information element of which the value is the second data is received from the terminal, the information element of which the value is the second data being used to indicate that the target type is the second type.

During implementation, after the terminal sends the signaling including the information element of which the value is the second data to the base station, the base station may receive the signaling including the information element of which the value is the second data from the terminal. Optionally, when the first data is true, the second data may be false; and when the first data is the identifier of the first type, the second data may be the identifier of the second type.

In Step 204, the base station determines the target type indicated by the information. During implementation, the base station, after receiving the signaling sent by the terminal, may parse the received signaling to acquire the information indicating that the core network type corresponding to the core network to be accessed by the terminal is the target type, and determine the target type indicated by the information. Optionally, in condition that the signaling received by the base station includes the information element of which the value is the first data, correspondingly, the processing process of Step 204 may be as follows: it is determined that the target type indicated by the information is the first type.

During implementation, after receiving the signaling including the information element of which the value is the first data from the terminal, the base station may determine that the target type indicated by the information contained in the signaling is the first type. Optionally, in condition that the signaling received by the base station does not include the information element of which the value is the first data, or, in condition that the signaling received by the base station includes the information element of which the value is the second data, the processing process of Step 204 may be as follows: it is determined that the target type indicated by the information is the second type.

During implementation, after receiving the signaling excluding the information element of which the value is the first data from the terminal, the base station may determine that the target type indicated by the information in the signaling is the second type. Or, after receiving the signaling including the information element of which the value is the second data from the terminal, the base station may determine that the target type indicated by the information in the signaling is the second type.

In Step 205, the base station establishes a connection between the terminal and a core network corresponding to the target type, where the core network corresponding to the target type is the core network to be accessed by the terminal. During implementation, the base station, after determining the target type indicated by the information in the signaling, may establish a connection between the terminal and the core network corresponding to the target type. Therefore, the base station may establish a connection between the terminal and the core network to be accessed by the terminal, namely the terminal may correctly access the core network that is expected to be accessed by the terminal. Specifically, if the base station determines that the target type is the first type, the base station may establish a connection between the terminal and a core network corresponding to the first type, and if the base station determines that the target type is the second type, the base station may establish a connection between the terminal and a core network corresponding to the second type.

In the embodiment of the present disclosure, the terminal may determine the target type corresponding to the core network to be accessed and send the signaling to the base station, the signaling including the information indicating that the core network type corresponding to the core network to be accessed by the terminal is the target type. Correspondingly, the base station, after receiving the signaling sent by the terminal, may determine the target type indicated by the information in the signaling and establish the connection between the terminal and the core network corresponding to the target type, where the core network corresponding to the target type is the core network to be accessed by the terminal. Therefore, the base station may correctly establish the connection between the terminal and the core network to be accessed by the terminal. In this way, the embodiment of the present disclosure provides a method for establishing a connection between a terminal and a core network to be accessed.

Based on the same technical concept, another exemplary embodiment of the present disclosure provides a device for establishing a connection between a terminal and a core network to be accessed. The device may be the abovementioned terminal. As shown in FIG. 4, the device includes: a determination module 410 and a sending module 420. The determination module 410 is configured to determine a target type corresponding to a core network to be accessed.

The sending module 420 is configured to send signaling to a base station, the signaling including information for indicating that a core network type corresponding to the core network to be accessed by a terminal is the target type. Optionally, the sending module 420 is configured to, if the target type is a first type, send signaling including an information element of which a value is first data to the base station, the information element of which the value is the first data being used to indicate that the target type is the first type.

Optionally, the sending module 420 is configured to send, if the target type is a second type, signaling excluding the information element of which the value is the first data to the base station, or send, if the target type is the second type, signaling including an information element of which a value is second data to the base station, the information element of which the value is the second data being used to indicate that the target type is the second type. Optionally, when the first data is true, the second data is false, and when the first data is an identifier of the first type, the second data is an identifier of the second type.

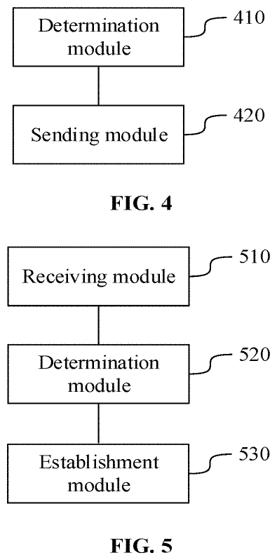

Based on the same technical concept, another exemplary embodiment of the present disclosure provides a device for establishing a connection between a terminal and a core network to be accessed. The device may be the abovementioned base station. As shown in FIG. 5, the device can include a receiving module 510, a determination module 520 and an establishment module 530.

The receiving module 510 is configured to receive signaling sent by a terminal, the signaling including information for indicating that a core network type corresponding to a core network to be accessed by the terminal is a target type. The determination module 520 is configured to determine the target type indicated by the information. The establishment module 530 is configured to establish a connection between the terminal and a core network corresponding to the target type, where the core network corresponding to the target type is the core network to be accessed by the terminal.

Optionally, the receiving module 510 is configured to receive signaling including an information element of which a value is first data from the terminal, the information element of which the value is the first data being used to indicate that the target type is a first type, and the determination module 520 is configured to determine that the target type indicated by the information is the first type.

Optionally, the receiving module 510 is configured to receive signaling excluding the information element of which the value is the first data from the terminal, or, receive signaling including an information element of which a value is second data from the terminal, the information element of which the value is the second data being used to indicate that the target type is a second type, and the determination module 520 is configured to determine that the target type indicated by the information is the second type. Optionally, when the first data is true, the second data is false, and when the first data is an identifier of the first type, the second data is an identifier of the second type.

In the embodiment of the present disclosure, the terminal may determine the target type corresponding to the core network to be accessed and send the signaling to the base station, the signaling including the information for indicating that the core network type corresponding to the core network to be accessed by the terminal is the target type. The base station, after receiving the signaling sent by the terminal, may determine the target type indicated by the information in the signaling and establish the connection between the terminal and the core network corresponding to the target type, where the core network corresponding to the target type is the core network to be accessed by the terminal. In this way, the base station may correctly establish the connection between the terminal and the core network to be accessed by the terminal, namely the embodiment of the present disclosure provides a method for establishing a connection between a terminal and a core network to be accessed.

It is to be noted that during establishment of a connection between the terminal and a core network to be accessed, the device for establishing the connection between the terminal and the core network to be accessed in the embodiments is only described with division of each abovementioned functional module as an example and, during practical application, the abovementioned functions may be allocated to different functional modules for realization according to a requirement, that is, internal structures of a base station and a terminal are divided into different functional modules to realize all or part of the functions described above. In addition, the device for establishing the connection between the terminal and the core network to be accessed in the embodiment belongs to the same concept of the method embodiment for establishing the connection between the terminal and the core network to be accessed, details about a specific implementation process thereof refer to the method embodiment, and elaborations are omitted herein.

Based on the same technical concept, another exemplary embodiment of the present disclosure provides a system for establishing a connection between a terminal and a core network to be accessed. The system includes a terminal and a base station.

The terminal is configured to determine a target type corresponding to a core network to be accessed and send signaling to the base station, the signaling including information for indicating that a core network type corresponding to the core network to be accessed by the terminal is the target type.

The base station is configured to receive the signaling from the terminal, determine the target type indicated by the information in the signaling and establish a connection between the terminal and a core network corresponding to the target type, where the core network corresponding to the target type is the core network to be accessed by the terminal.

In the embodiment of the present disclosure, the terminal may determine the target type corresponding to the core network to be accessed and send the signaling to the base station, the signaling including the information for indicating that the core network type corresponding to the core network to be accessed by the terminal is the target type. Correspondingly, the base station, after receiving the signaling from the terminal, may determine the target type indicated by the information in the signaling and establish the connection between the terminal and the core network corresponding to the target type, where the core network corresponding to the target type is the core network to be accessed by the terminal. In this way, the base station may correctly establish the connection between the terminal and the core network to be accessed by the terminal, namely the embodiment of the present disclosure provides a method for establishing a connection between a terminal and a core network to be accessed.

A structure diagram of a terminal according to an embodiment of the present disclosure is also shown. The terminal may be a mobile phone, a tablet computer, and the like.

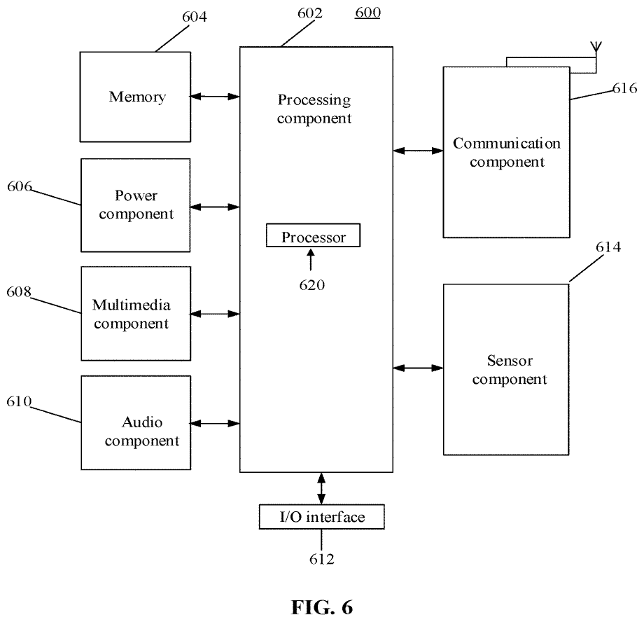

Referring to FIG. 6, the terminal 600 may include one or more of the following components: a processing component 602, a memory 604, a power component 606, a multimedia component 608, an audio component 610, an Input/Output (I/O) interface 612, a sensor component 614, and a communication component 616.

The processing component 602 typically controls overall operations of the terminal 600, such as the operations associated with display, telephone calls, data communications, camera operations, and recording operations. The processing component 602 may include one or more processors 620 to execute instructions to perform all or part of the steps in the abovementioned method. Moreover, the processing component 602 may include one or more modules which facilitate interaction between the processing component 602 and the other components. For instance, the processing component 602 may include a multimedia module to facilitate interaction between the multimedia component 608 and the processing component 602.

The memory 604 is configured to store various types of data to support the operations of the terminal 600. Examples of such data include instructions for any application programs or methods operated on the terminal 600, contact data, phonebook data, messages, pictures, video, etc. The memory 604 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 606 provides power for various components of the terminal 600. The power component 606 may include a power management system, one or more power supplies, and other components associated with generation, management and distribution of power for the audio output device 600.

The multimedia component 608 includes a screen providing an output interface between the terminal 600 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 608 includes a front camera and/or a rear camera. The front camera and/or the rear camera may receive external multimedia data when the terminal 600 is in an operation mode, such as a photographing mode or a video mode. Each of the front camera and the rear camera may be a fixed optical lens system or have focusing and optical zooming capabilities.

The audio component 610 is configured to output and/or input an audio signal. For example, the audio component 610 includes a Microphone (MIC), and the MIC is configured to receive an external audio signal when the audio output device 600 is in the operation mode, such as a call mode, a recording mode and a voice recognition mode. The received audio signal may further be stored in the memory 604 or sent through the communication component 616.

The I/O interface 612 provides an interface between the processing component 602 and a peripheral interface module, and the peripheral interface module may be a keyboard, a click wheel, a button and the like. The button may include, but not limited to a home button, a volume button, a starting button and a locking button.

The sensor component 614 includes one or more sensors configured to provide status assessment in various aspects for the terminal 600. For instance, the sensor component 614 may detect an on/off status of the terminal 600 and relative positioning of components, such as a display and small keyboard of the terminal 600, and the sensor component 614 may further detect a change in a position of the terminal 600 or a component of the terminal 600, presence or absence of contact between the user and the terminal 600, orientation or acceleration/deceleration of the terminal 600 and a change in temperature of the terminal 600. The sensor component 614 may include a proximity sensor configured to detect presence of an object nearby without any physical contact. The sensor component 614 may also include a light sensor, such as a Complementary Metal Oxide Semiconductor (CMOS) or Charge Coupled Device (CCD) image sensor, configured for use in an imaging application. In some embodiments, the sensor component 614 may also include an acceleration sensor, a gyroscope sensor, a magnetic sensor, a pressure sensor or a temperature sensor.

The communication component 616 is configured to facilitate wired or wireless communication between the terminal 600 and another device. The terminal 600 may access any communication-standard-based wireless network, such as a Wireless Fidelity (WiFi) network, a 2nd-Generation (2G) or 3rd-Generation (3G) network or a combination thereof. In an exemplary embodiment, the communication component 616 receives a broadcast signal or broadcast associated information from an external broadcast management system through a broadcast channel. In an exemplary embodiment, the communication component 616 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a Bluetooth (BT) technology, and another technology.

In an exemplary embodiment, the terminal 600 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In an exemplary embodiment, there is also provided a non-transitory computer-readable storage medium including an instruction, such as the memory 604 including an instruction, and the instruction may be executed by the processor 620 of the terminal 600 to implement the abovementioned method. For example, the non-transitory computer-readable storage medium may be a ROM, a RAM, a Compact Disc Read-Only Memory (CD-ROM), a magnetic tape, a floppy disc, an optical data storage device, and the like.

A non-transitory computer-readable storage medium is provided, where an instruction in the storage medium, when being executed by a processor of a terminal, enables the terminal to execute a method for establishing a connection between a terminal and a core network to be accessed, the method including that a target type corresponding to a core network to be accessed is determined, and signaling is sent to a base station, the signaling including information for indicating that a core network type corresponding to the core network to be accessed by a terminal is the target type. Optionally, the operation that the signaling is sent to the base station includes that if the target type is a first type, signaling including an information element of which a value is first data is sent to the base station, the information element of which the value is the first data being used to indicate that the target type is the first type.

The operation that the signaling is sent to the base station can include that if the target type is a second type, signaling excluding the information element of which the value is the first data is sent to the base station, or if the target type is the second type, signaling including an information element of which a value is second data is sent to the base station, the information element of which the value is the second data being used to indicate that the target type is the second type. Optionally, when the first data is true, the second data is false, and when the first data is an identifier of the first type, the second data is an identifier of the second type.

In the embodiment of the present disclosure, the terminal may determine the target type corresponding to the core network to be accessed and send the signaling to the base station, the signaling including the information for indicating that the core network type corresponding to the core network to be accessed by the terminal is the target type. The base station, after receiving the signaling sent by the terminal, may determine the target type indicated by the information in the signaling and establish the connection between the terminal and the core network corresponding to the target type, where the core network corresponding to the target type is the core network to be accessed by the terminal. In this way, the base station may correctly establish the connection between the terminal and the core network to be accessed by the terminal, namely the embodiment of the present disclosure provides a method for establishing a connection between a terminal and a core network to be accessed.

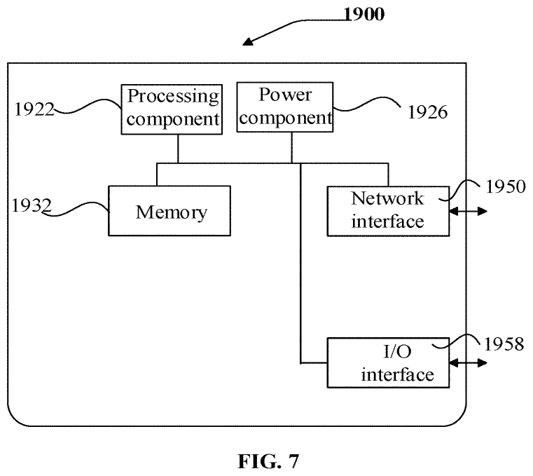

FIG. 7 is a block diagram of a device 1900 for establishing a connection between a terminal and a core network to be accessed, according to an exemplary embodiment. For example, the device 1900 may be provided as a base station. Referring to FIG. 7, the device 1900 includes a processing component 1922, one or more processors, and a memory resource represented by a memory 1932 configured to store an instruction executable by the processing component 1922, for example, an application program. The application program stored in the memory 1932 may include one or more modules, each of which corresponds to a set of instructions. In addition, the processing component 1922 is configured to execute the instruction to implement the method for establishing the connection between the terminal and the core network to be accessed.

The device 1900 may further include a power component 1926 configured to execute power management of the device 1900, a wired or wireless network interface 1950 configured to connect the device 1900 to a network and an I/O interface 1958. The device 1900 may be operated based on an operating system stored in the memory 1932, for example, Windows Server™, Mac OS X™, Unix™, Linux™, FreeBSD™, or the like.

The device 1900 may include a memory and one or more program. The one or more programs are stored in the memory and configured to be executed by one or more processors. The one or more programs include instructions for implementing the following operations signaling is received from a terminal, the signaling including information for indicating that a core network type corresponding to a core network to be accessed by the terminal is a target type, the target type indicated by the information is determined, and a connection is established between the terminal and a core network corresponding to the target type, where the core network corresponding to the target type is the core network to be accessed by the terminal.

Optionally, the operation that the signaling is received from the terminal includes that signaling including an information element of which a value is first data is received from the terminal, the information element of which the value is the first data being configured to indicate that the target type is a first type, and the operation that the target type indicated by the information is determined includes that it is determined that the target type indicated by the information is the first type.

Optionally, the operation that the signaling is received from the terminal includes that signaling excluding the information element of which the value is the first data is received from the terminal, or signaling including an information element of which a value is second data is received from the terminal, the information element of which the value is the second data being configured to indicate that the target type is a second type. Further, the operation that the target type indicated by the information is determined includes that it is determined that the target type indicated by the information is the second type. Optionally, when the first data is true, the second data is false. When the first data is an identifier of the first type, the second data is an identifier of the second type.

There is also provided a non-transitory computer-readable storage medium in an exemplary embodiment, for storing at least one instruction, at least one program, a code set or an instruction set that, when being executed by a processor, enables the processor to implement the method for establishing the connection between the terminal and the core network to be accessed.

In the embodiment of the present disclosure, the terminal may determine the target type corresponding to the core network to be accessed and send the signaling to the base station, the signaling including the information configured to indicate that the core network type corresponding to the core network to be accessed by the terminal is the target type. Correspondingly, the base station, after receiving the signaling sent by the terminal, may determine the target type indicated by the information in the signaling and establish the connection between the terminal and the core network corresponding to the target type, where the core network corresponding to the target type is the core network to be accessed by the terminal. In this way, the base station may correctly establish the connection between the terminal and the core network to be accessed by the terminal, namely the embodiment of the present disclosure provides a method for establishing a connection between a terminal and a core network to be accessed.

Those of ordinary skill in the art should know that implementation of all or part of the steps of the abovementioned embodiments may be completed through hardware and may also be completed through related hardware instructed by a program. The program may be stored in a computer-readable storage medium. The storage medium may be a ROM, a magnetic disk, an optical disc, or the like.

The above is only the preferred embodiments of the present disclosure and not intended to limit the present disclosure. Any modifications, equivalent replacements, improvements and the like made within the spirit and principle of the present disclosure shall fall within the scope of protection of the present disclosure.

1. A method for establishing a connection between a terminal and a core network to be accessed, the method comprising:
determining, by a terminal, a target type corresponding to a core network to be accessed; and
sending signaling to a base station that includes information indicating that a core network type corresponding to the core network to be accessed by the terminal is the target type.

2. The method of claim 1, wherein sending, by the terminal, the signaling to the base station further comprises:
sending, if the target type is a first type, signaling including an information element of which a value is first data to the base station, the information element of which the value is the first data being used to indicate that the target type is the first type.

3. The method of claim 2, wherein sending the signaling to the base station further comprises:
sending, if the target type is a second type, signaling excluding the information element of which the value is the first data to the base station; or
sending, if the target type is the second type, signaling including an information element of which a value is second data to the base station, the information element of which the value is the second data being used to indicate that the target type is the second type.

4. The method of claim 2, wherein:
when the first data is true, the second data is false, and
when the first data is an identifier of the first type, the second data is an identifier of the second type.

5. A method for establishing a connection between a terminal and a core network to be accessed, the method comprising:
receiving, by a base station, signaling from a terminal, the signaling including information for indicating that a core network type corresponding to a core network to be accessed by the terminal is a target type;
determining, by the base station, the target type indicated by the information; and
establishing, by the base station, a connection between the terminal and a core network corresponding to the target type, wherein the core network corresponding to the target type is the core network to be accessed by the terminal.

6. The method of claim 5, wherein receiving, by the base station, the signaling from the terminal further comprises:
receiving signaling including an information element of which a value is first data from the terminal, the information element of which the value is the first data being used to indicate that the target type is a first type; and
determining, by the base station, the target type indicated by the information includes
determining that the target type indicated by the information is the first type.

7. The method of claim 5, wherein receiving, by the base station, the signaling from the terminal further comprises:
receiving signaling excluding the information element of which the value is the first data from the terminal, or
receiving signaling including an information element of which a value is second data from the terminal, the information element of which the value is the second data being used to indicate that the target type is a second type; and
determining, by the base station, the target type indicated by the information
includes determining that the target type indicated by the information is the second type.

8. The method of claim 6, wherein:
when the first data is true, the second data is false, and
when the first data is an identifier of the first type, the second data is an identifier of the second type.

9. A terminal, comprising transceiver, one or more processors, and a memory for storing instructions executed by the processor, wherein:
the one or more processors are configured to determine a target type corresponding to a core network to be accessed; and
the transceiver is configured to send signaling to a base station, the signaling including information for indicating that a core network type corresponding to the core network to be accessed by the terminal is the target type.

10. The terminal of claim 9, wherein the transceiver is further configured to:
send, if the target type is a first type, signaling including an information element of which a value is first data to the base station, the information element of which the value is the first data being used to indicate that the target type is the first type.

11. The terminal of claim 10, wherein the transceiver is further configured to:
send, if the target type is a second type, signaling excluding the information element of which the value is the first data to the base station, or
send, if the target type is the second type, signaling including an information element of which a value is second data to the base station, the information element of which the value is the second data being used to indicate that the target type is the second type.

12. The terminal of claim 10, wherein;
when the first data is true, the second data is false;
when the first data is an identifier of the first type, the second data is an identifier of the second type.

13. A base station implementing the method of claim 5, comprising:
a transceiver, one or more processors, and a memory for storing instructions executed by the processor,
wherein
the one or more processes are configured to cooperate with the transceiver to implement operations of the method.

14. The base station of claim 13, wherein the transceiver is configured to:
receive signaling including an information element of which a value is first data from the terminal, the information element of which the value is the first data being used to indicate that the target type is a first type; and
the one or more processors are configured to determine that the target type indicated by the information is the first type.

15. The base station of claim 13, wherein the transceiver is further configured to:
receive signaling excluding the information element of which the value is the first data from the terminal, or
receive signaling including an information element of which a value is second data from the terminal, the information element of which the value is the second data being used to indicate that the target type is a second type; and
the one or more processors are configured determine that the target type indicated by the information is the second type.

16. The base station of claim 14, wherein:
when the first data is true, the second data is false;
when the first data is an identifier of the first type, the second data is an identifier of the second type.

17. (canceled)

18. (canceled)

19. A non-transitory computer-readable storage medium, having stored therein at least one instruction that, when executed by a processor, enables the processor to implement the method for establishing the connection between the terminal and the core network to be accessed of claim 1.

20. A system for establishing a connection between a terminal and a core network to be accessed, comprising a terminal and a base station, where
n the terminal is the terminal of claim 9.

21. A system for establishing a connection between a terminal and a core network to be accessed, comprising a terminal and a base station, wherein the base station is the base station of claim 13.

22. A non-transitory computer-readable storage medium, having stored therein at least one instruction that, when executed by a processor, enables the processor to implement the method for establishing the connection between the terminal and the core network to be accessed of claim 5.
